(19) United States
(12) Patent Application Publication
(10) Pub. No.: US 2019/0323536 A1
(43) Pub. Date: Oct. 24, 2019

(54) CLOSURE ELEMENT FOR CLOSING AND SEALING BORES THAT ARE SUBJECT TO INTERNAL PRESSURE

(71) Applicant: BAIER & MICHELS GMBH & CO. KG, Ober-Ramstadt (DE)

(72) Inventors: Michael LENDLE, Wiesbaden (DE); Eugen KRAUS, Schriesheim (DE)

(21) Appl. No.: 16/312,919

(22) PCT Filed: Jun. 23, 2017
(86) PCT No.: PCT/EP2017/065483

§ 371 Date: Dec. 21, 2018

(30) Foreign Application Priority Data
Jun. 23, 2016 (DE) 10 2016 211 282.1

(51) Int. Cl. F16B 19/10

(52) U.S. Cl. CPC F16B 19/1072

(57) ABSTRACT

A blind rivet nut for introduction into an opening of one or more components, comprising a hollow shank having a front end for placing an assembly tool and a rear end for introduction into and/or passage through the opening. The shank has a deformation portion with a first wall thickness (t1) and an adjacent threaded portion with a second wall thickness (t2) that is greater than the first wall thickness (t1), the threaded portion having an internal screw thread. The shank has a predetermined breaking point in an area of the threaded portion and/or the deformation portion, the predetermined breaking point being designed such in terms of its position and orientation that the threaded portion dips into the deformation portion when the shank is tensioned in the axial direction after breaking at the predetermined breaking point.

### OBJECT OF THE INVENTION

The invention pertains to a closure element for closing and sealing bores that are subject to internal pressure.

### PRIOR ART

A self-plugging blind rivet with a closed end for connecting two workpieces and for sealing an opening in the two workpieces used for this connection is disclosed in EP 0 536 957 B1, wherein the corresponding German translation is published as DE 692 10 162 T2. The opening in the workpiece is filled during the deformation of a collapsible portion of a shank of the blind rivet by means of bulging and crimping. The stem head of the blind rivet tears off at a predetermined breaking point and remains in the set rivet. In this case, it is disadvantageous that no screw thread can be made available.

EP 0 305 868 discloses a blind rivet with the deformation portion and a threaded portion that has an internal screw thread, wherein the wall thickness of the deformation portion is conically reduced starting from the threaded portion. The blind rivet can thereby be used on components with different thicknesses. In this case, it is disadvantageous that no seal is produced.

EP 0 494 747 A1 discloses a blind rivet with a deformation portion and a threaded portion that has an internal screw thread, wherein the wall thickness of the threaded portion is significantly larger than the wall thickness of the deformation portion in order to prevent a deformation of the screw thread when the rivet is set. In this case, it is disadvantageous that no seal is produced.

DE 36 23 123 proposes to provide a blind rivet with a plug that is located on a rod, wherein said plug penetrates into a cylindrical shank of the blind rivet with a conical portion and radially expands. In this case, it is disadvantageous that the component consists of multiple parts and that no screw thread can be made available.

The invention is therefore based on the objective of disclosing a blind rivet that comprises a screw thread and makes it possible to produce a seal with a small number of components.

### DISCLOSURE OF THE INVENTION

The inventive blind rivet nut for being introduced into an opening of one or more components comprises a hollow shank that has a front end for attaching an installation tool and a rear end for being introduced into and/or passing through the opening. The shank has a deformation portion with a first wall thickness t1 and an adjacent threaded portion with a second wall thickness t2 that is greater than the first wall thickness t1, wherein the threaded portion is provided with an internal screw thread. The shank has a predetermined breaking point in the region of the threaded portion and/or the deformation portion, wherein said predetermined breaking point is with respect to its position and orientation designed such that the threaded portion penetrates into the deformation portion when the shank is tensioned in the axial direction after breaking at the predetermined breaking point.

The special feature of this blind rivet nut is that the shank consists of a cylindrical base body with a deformation portion and a threaded portion, which is integrally connected to the deformation portion and acts as an expansion member. Since the deformation portion undergoes a plastic deformation radially outward when it is pushed together with and penetrated by the threaded portion acting as an expansion member, a radial pressure is exerted upon the inner wall of the bore or opening such that the bore or opening is sealed. In this way, the blind rivet nut acts as a closure element. This closure element may consist of different materials and be manufactured in different diameters.

The closure element can likewise be used for repair purposes. Holes, which were accidentally drilled incorrectly, can be sealed and simultaneously used for a smaller screw.

In comparison with the installation of a blind rivet, this blind rivet nut has the advantage that no waste product is created during its installation.

The properties of the invention can also be used for producing a screw thread, e.g., in existing larger bores. For example, a screw anchor system with an arbitrary screw thread such as a metric thread or an inch-based thread can be realized in this case.

This makes it possible to mount all components, for example, with a conventional metric screw.

This invention likewise comprises a tool for dismounting the closure element without compromising the properties of the existing bore.

Depending on the respective requirements, the deformation portion of the blind rivet nut, which acts as a sealing member, may comprise radial grooves. These grooves serve for accommodating the displaced material. Since tolerances occur during the manufacturing process of the blind rivet nut and the bore to be sealed is naturally also subject to manufacturing tolerances, the radial grooves serve for accommodating material, which is created by an inaccurate fit, during the deformation. If the bore is excessively narrow, the threaded portion, which acts as an expansion member, builds up such a high pressure in the deformation portion, which acts as a sealing member, that the deformation process cannot be completely finished. The grooves can decrease the pressure to a certain extent by deforming and accommodating material. After the completed deformation process, the grooves are once again flat and filled with material.

### BRIEF DESCRIPTION OF THE DRAWINGS

The invention is described below with reference to the drawings. In these drawings:

FIG. 1 shows the blind rivet nut prior to its installation in the form of the section AA in FIG. 2;

FIG. 2 shows the blind rivet nut according to FIG. 1 in the form of a top view;

FIG. 3 shows a detail of FIG. 1;

FIGS. 4A-C show various other potential embodiments in the form of detailed views;

FIGS. 5A-G show the installation sequence; and

FIG. 6 shows the dismounting sequence.

### EXEMPLARY EMBODIMENTS OF THE INVENTION

The present invention comprises a closure element for closing bores in a sealed manner in a variety of applications. This closure element is suitable for a variety of diameters and pressure loads.

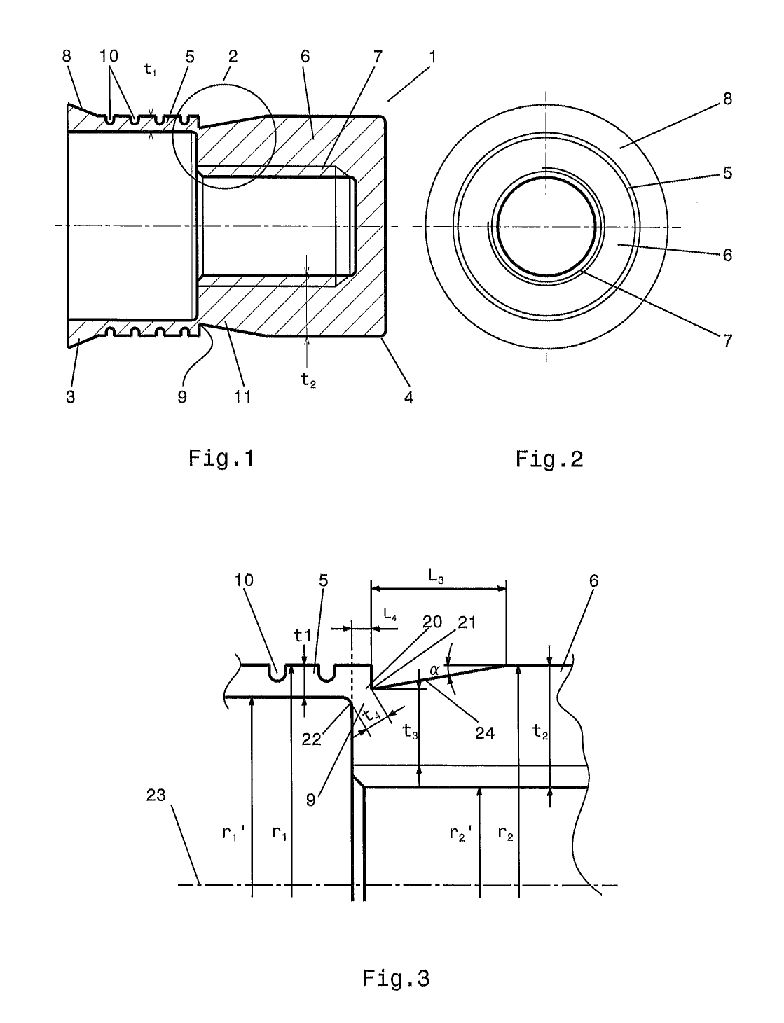

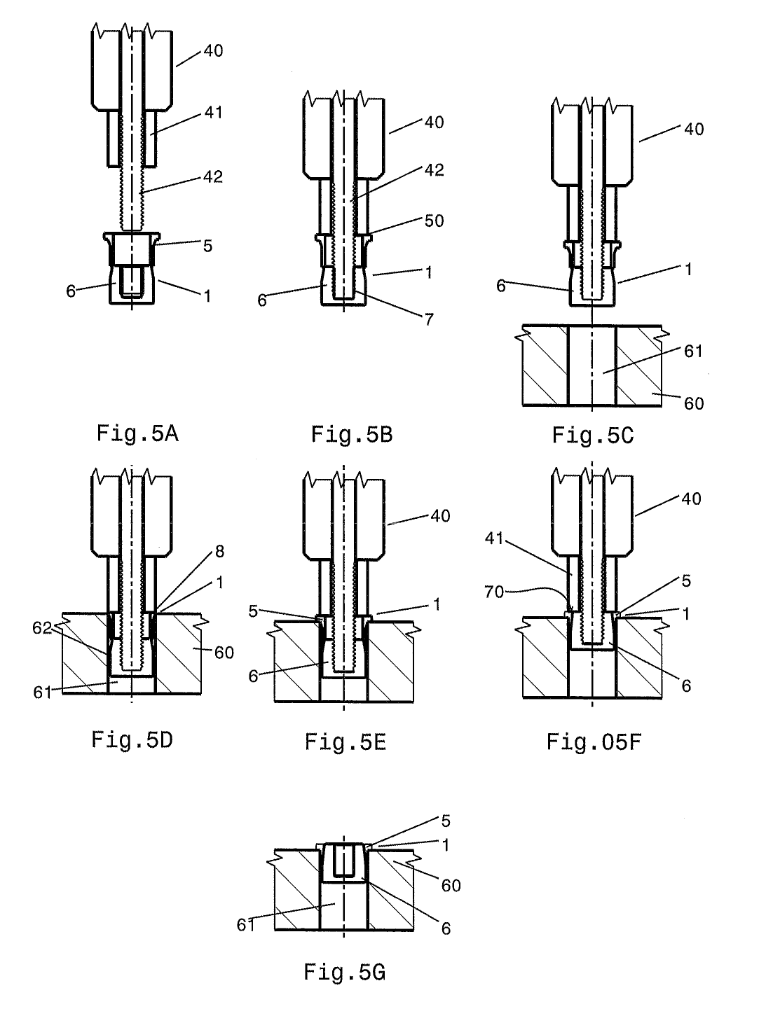

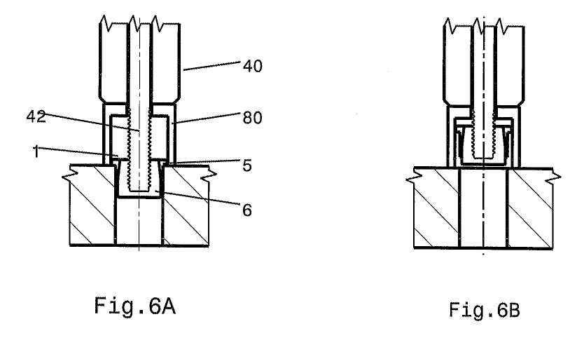

FIG. 1 shows a blind rivet nut 1 for being introduced into an opening of one or more components prior to its installation, wherein the blind rivet nut 1 is in the present example used as a closure element for a bore or an opening in a workpiece. The blind rivet nut 1 consists of a hollow shank 2 that is formed of one piece. In this case, the blind rivet nut 1 has a front end 3 for attaching an installation tool and a rear end 4 for being introduced into and/or passing through the opening, wherein the shank 2 of the front end 3 comprises a deformation portion 5 with a first wall thickness t1 and an adjacent threaded portion 6 with a second wall thickness t2 that is greater than the first wall thickness t1, and wherein the threaded portion 6 is provided with an internal screw thread 7. According to FIGS. 5A-G, the blind rivet nut 1 may have different head shapes such as a flat head, but also a countersunk head with a bevel that is arranged on the head and widens toward the end of the head. The blind rivet nut 1 may also be realized without a head as illustrated in FIG. 1.

An outwardly widening bevel 8 is located on the front end of the shank in order to correctly position the closure element in an existing bore as illustrated in FIG. 5c. The closure element 1 can be centered in the bore with the aid of this bevel 8.

Since the outside diameter of the blind rivet nut 1 has to be smaller than the hole to be closed, a uniform insertion of the deformation portion can be ensured by means of a bevel 8. The bevel 8 ensures a centered insertion. As the setting process begins, pressure is exerted upon the blind rivet nut 1 and the bevel 8 is uniformly pressed into the bore such that the entire element is centered.

Parts of the bevel 8 or the deformation portion 5 may still protrude above the bore after the setting process. The bevel 8 is not required on a countersunk head.

Furthermore, the bevel 8 can adapt itself to the geometry of the bore during the deformation process of the blind rivet nut 1 and therefore additionally seal the bore.

A threaded pin, which is provided on an installation and dismounting tool and described in greater detail below, is screwed into the internal screw thread 7.

The shank 2 has a predetermined breaking point 9 in the region of the threaded portion 6 and/or the deformation portion 5, wherein said predetermined breaking point is with respect to its position and orientation designed such that the threaded portion 6 penetrates into the deformation portion 5 when the shank 2 is tensioned in the axial direction after breaking at the predetermined breaking point 9.

The blind rivet nut 1 is therefore separated at the defined predetermined breaking point 9 when the deformation process takes place during the installation and the separated parts 5, 6 are pulled into one another. Consequently, the blind rivet nut 1 is separated at the predetermined breaking point 9 such that the threaded portion 6 functionally forms an expansion member and the deformation portion 5 functionally forms a sealing member. A frictional and form-fitting connection between the threaded portion 6 and the deformation portion 5 is produced during this entire process. This frictional and form-fitting connection ensures the radial pressure against the inner wall of the bore to be sealed. A frictional connection is produced due to the radial force exerted upon the component. The deformation portion 5 adapts to the geometry of the bore to be sealed during the deformation process such that a form-fitting connection is produced.

Depending on the respective requirements, the deformation portion 5, which acts as a sealing member, may comprise radial grooves 10. These grooves serve for accommodating the displaced material.

An insertion bevel 11 is provided on the threaded portion 6.

FIG. 2 shows the blind rivet nut 1 according to FIG. 1 in the form of a top view with a plane of section A, wherein this blind rivet nut comprises the deformation portion 5 with the bevel 8 and the threaded portion 7 with the internal screw thread 7.

FIG. 3 shows a detail of the blind rivet nut 1 according to FIG. 1, wherein the threaded portion 6 has a connecting region 20 with the length L4, which is located adjacent to the deformation portion 5 and comprises the predetermined breaking point 9. The threaded portion 6 has a third wall thickness t3 at the transition to the connecting region. 20. This figure also shows that the minimum wall thickness t4 of the predetermined breaking point 9 in the connecting region 20 is smaller than the first wall thickness t1 of the deformation portion 5 and smaller than the third wall thickness t3 at the transition to the connecting region 20.

In this case, the wall thickness t4 of the predetermined breaking point 9 is the shortest distance between an outer surface 21 and an inner surface 22 of the blind rivet nut 1 whereas the other wall thicknesses t1, t2 and t3 are always measured in the direction toward a center axis 23.

The blind rivet nut can also be used as a closure element for making available a screw thread in the form of a screw anchor in a workpiece with an opening or bore. For example, the screw thread may be a metric thread. In this way, a commercially available metric screw can be used, for example, for mounting other components on the workpiece.

Depending on the respective dimensions of the required screw, it is expected that the closure element can transmit different torques. A special geometric feature may be added to the surface area of the deformation portion 5 in order to absorb high torques.

An insertion bevel 11 is provided on the threaded portion 6 and, after breaking the blind rivet nut 1, serves for inserting the threaded portion 6, which now acts as an expansion member, into the deformation portion 5, which acts as a sealing member, in a predefined manner. The correspondingly specified path is adjusted by means of the installation tool, which is described in greater detail below.

The threaded portion 6 has a taper 24, wherein the threaded portion 6 is on its outer circumference conically tapered in the direction toward the deformation portion 5 over a length L3. In the example shown, the cone angle a of the taper 24 on the threaded portion 6 amounts to 15°.

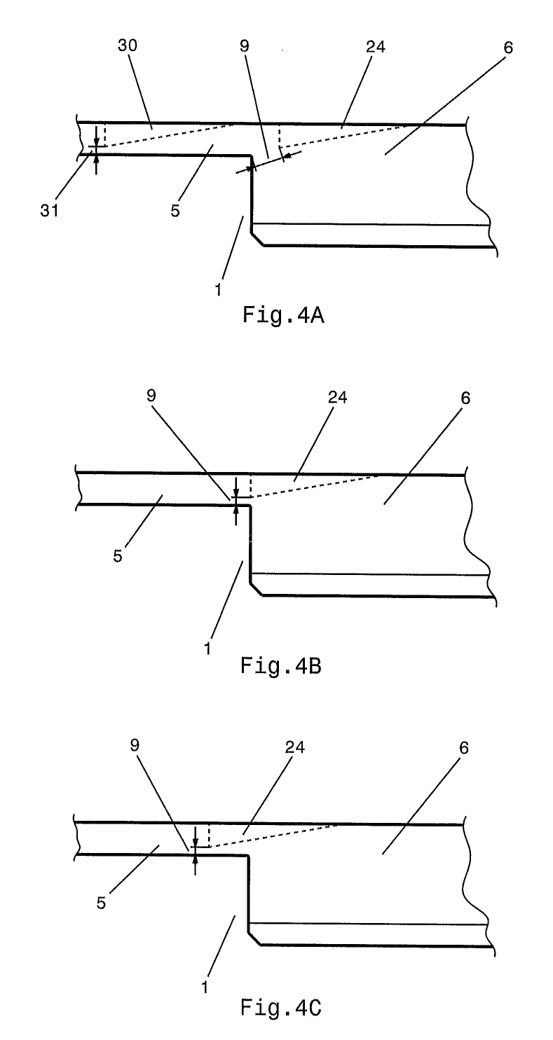

FIGS. 4A-C show various other potential embodiments of the blind rivet nut 1 in the form of detailed views. In FIG. 4A, the blind rivet nut 1 comprises a first taper 24 with a first predetermined breaking point 9 on the threaded portion 6 and a second taper 30 with a second predetermined breaking point 31. Consequently, the blind rivet nut 1 breaks at the first predetermined breaking point 9 and at the second predetermined breaking point 31 when pulling on the threaded portion 6 by means of an installation tool. The frictional and form-fitting connection between the set blind rivet nut 1 and the bore to be sealed is thereby enhanced.

In FIG. 4B, the blind rivet nut 1 only comprises one taper 24 with the first predetermined breaking point 9 as in FIG. 1, wherein the predetermined breaking point 9 has a shorter minimum wall thickness t4 than in FIG. 1.

In FIG. 4C, the blind rivet nut 1 comprises a taper 24 with a predetermined breaking point 9 that is arranged in the deformation portion 5.

FIG. 5A shows the blind rivet nut 1 with the deformation portion 5 and the threaded portion 6 prior to its connection to an installation tool 40. The installation tool 40 used is a blind rivet nut setter with force-path adjustment. In addition, a special mouthpiece 41 and an adapted threaded pin 42 are required for the installation tool 40.

In FIG. 5B, the blind rivet nut 1 is screwed on the tool 40 until it reaches a stop 50 on the tool 40, wherein the threaded pin 42 is screwed into the internal screw thread 7 of the threaded portion 6.

The exact adaptation of the mouthpiece 41 and the threaded pin 42 depends on the space conditions in the respective application and on the head geometry of the blind rivet nut 1.

FIG. 5C shows how the tool 40 with the blind rivet nut 1 is held on a workpiece 60 in order to insert the blind rivet nut 1 into an opening or bore 61 in the workpiece 60. The workpiece 60 may also be composed of multiple layers, wherein the openings of the multiple layers lie on top of one another.

FIG. 5D shows the insertion of the blind rivet nut 1 into the bore 61, wherein the blind rivet nut 1 obviously has a smaller diameter than the bore 61 such that a gap 62 is formed. The bevel 8 ensures a centered insertion. As the setting process begins, pressure is exerted upon the blind rivet nut 1 and the bevel 8 is uniformly pressed into the bore 61 such that the blind rivet nut 1 is centered.

The workpiece 60 does not have to be thicker than the length of the deformation portion 5. However, a blind bore must be at least as long as the blind rivet nut 1.

FIG. 5E shows that the lifting motion of the tool 40 and of the threaded portion 6 connected to the tool 40 causes the threaded portion, which acts as a spreading element, to be partially pulled into the deformation portion 5, which then acts as a sealing element, after the material of the blind rivet nut 1 is broken at the predetermined breaking point 9. A plastic deformation of the deformation portion 5 is thereby initiated.

In FIG. 5F, the lifting process of the tool 40 and of the threaded portion 7 and therefore also the deformation process are completed. Due to the applied force, the threaded portion 6 comes in contact with the mouthpiece 41 of the tool 41 with a stopping surface 70 on its upper side.

In FIG. 5G, the tool 40 is unscrewed from the blind rivet nut 1 and the bore 61 is now tightly sealed relative to the workpiece 60 as a result of the plastic and elastic radial deformation of the deformation portion 5. Due to the force exerted for the radial deformation, the threaded portion 6, which has penetrated into the deformation portion 5, is likewise tight relative to this deformation portion and therefore also seals the bore 61 with its closed end.

The same installation tool 40 as in FIGS. 5A-5F can be used for dismounting the blind rivet nut. According to FIG. 6A, the mouthpiece 41 of FIG. 5A is replaced with a support sleeve 80. The support sleeve 80 is supported on the workpiece 60 and the threaded pin 42, which is screwed into the threaded portion 6 of the blind rivet nut 1, pulls the complete blind rivet nut 1 with its deformation portion 5 and threaded portion 6 out of the bore 61 due to another lifting motion of the threaded pin 42 such that the bore is once again open.

1. A blind rivet nut for being introduced into an opening of one or more components, comprising a hollow shank that has a front end for attaching an installation tool and a rear end for being introduced into and/or passing through the opening, wherein the shank has a deformation portion with a first wall thickness (t1) and an adjacent threaded portion with a second wall thickness (t2) that is greater than the first wall thickness (t1), and wherein the threaded portion is provided with an internal screw thread, wherein the shank has a predetermined breaking point in a region of the threaded portion and/or the deformation portion, wherein said predetermined breaking point is with respect to its position and orientation designed such that the threaded portion penetrates into the deformation portion when the shank is tensioned in an axial direction after breaking at the predetermined breaking point, wherein the deformation portion is realized in the form of a sealing member and comprises radial grooves.

2. The blind rivet nut according to claim 1, wherein the threaded portion has a connecting region with a length (L4), which is located adjacent to the deformation portion and comprises the predetermined breaking point, wherein the threaded portion is on its outer circumference conically tapered in a direction toward the connecting region to a third wall thickness (t3) at a transition to the connecting region over a length (L3).

3. The blind rivet nut according to claim 2, wherein a minimum wall thickness (t4) of the predetermined breaking point in the connecting region is smaller than the first wall thickness (t1) of the deformation portion and smaller than the third wall thickness (t3) at the transition to the connecting region.

4. The blind rivet nut according to claim 1, wherein a cone angle (a) on the threaded portion lies between 5° and 45°.

5. The blind rivet nut according to claim 1, wherein a head in the form of a countersunk head or a flat head is formed on the front end of the shank.

6. The blind rivet nut according to claim 1, wherein an outwardly widening bevel is arranged on the front end of the shank in order to center the blind rivet nut in opening.

7. The blind rivet nut according to claim 1, wherein the threaded portion is closed and comprises a blind bore screw thread.

8. The blind rivet nut according to claim 7, wherein the blind rivet nut forms a closure element and/or as a sealing element.

9. The blind rivet nut according to claim 1, wherein the blind rivet nut forms a screw anchor, particularly with a metric thread.

10. The blind rivet nut according to claim 8, wherein a surface area of the deformation portion of the shank comprises geometric design elements, which increase torque absorption.

11. An installation tool for a setter for blind rivet nuts, wherein the setter has a force-path adjustment and is provided with an installation mouthpiece and a threaded pin, wherein the mouthpiece is adapted to a head geometry of a blind rive nut, and wherein a support sleeve, which is larger than the head geometry, is provided for dismounting the blind rivet nut.
